(19) United States
(12) Patent Application Publication
(10) Pub. No.: US 2023/0258801 A1
(43) Pub. Date: Aug. 17, 2023

(54) CONTROL DEVICE AND CONTROL METHOD

(71) Applicant: HONDA MOTOR CO., LTD., Tokyo (JP)

(72) Inventors: Gakuyo Fujimoto, Wako-shi (JP); Hideki Matsunaga, Wako-shi (JP); Takashi Matsumoto, Wako-shi (JP); Yuji Yasui, Wako-shi (JP)

(21) Appl. No.: 18/098,137

(22) Filed: Jan. 18, 2023

(30) Foreign Application Priority Data
Jan. 21, 2022 (JP) 2022-007775

(51) Int. Cl. G01S 17/08; G01S 7/48; G01S 17/931

(52) U.S. Cl. CPC G01S 17/08; G01S 7/4808; G01S 17/931

(57) ABSTRACT

A control device includes: a distance measuring device that detects an object; a support device that supports the distance measuring device; and a controller configured to detect a prescribed object and to control a state of the support device. When the object has been detected, the controller is configured to cause the distance measuring device to emit electromagnetic waves in a state in which the distance measuring device is supported in a first posture or at a first position and then to cause the distance measuring device to emit electromagnetic waves in a state in which the distance measuring device is supported in a second posture or at a second position to which a direction or a position of the distance measuring device changes in at least one of an upward direction and a downward direction from the first posture or the first position.

### CROSS-REFERENCE TO RELATED APPLICATION

Priority is claimed on Japanese Patent Application No. 2022-007775, filed Jan. 21, 2022, the content of which is incorporated herein by reference.

### Field

The present invention relates to a control device and a control method.

### Description of Related Art

In the related art, a technique for a single-seated electrified vehicle that can move on a walkway has been disclosed (Japanese Unexamined Patent Application, First Publication No. 2020-189536).

### SUMMARY

In the related art, processing associated with detection of an object near a mobile object has not been satisfactorily considered.

The present invention was made in consideration of the aforementioned circumstances, and an objective thereof is to provide a control device and a control method that can support more accurate detection of an object.

A control device and a control method according to the present invention employ the following configurations.

According to an aspect of the present invention, there is provided a control device that is mounted in a mobile object, the control device including: a distance measuring device that is mounted in the mobile object and that emits electromagnetic waves to detect an object on the basis of a result of detection of the electromagnetic waves bouncing back from the object; a support device that supports the distance measuring device; and a controller configured to detect a prescribed object present in a traveling direction of the mobile object and to control a state of the support device such that a support state of the distance measuring device changes between at least a first posture and a second posture or changes between a first position and a second position, wherein, when the object has been detected, the controller is configured to cause the distance measuring device to emit electromagnetic waves in a state in which the distance measuring device is supported in the first posture or at the first position and then to cause the distance measuring device to emit electromagnetic waves in a state in which the distance measuring device is supported in the second posture or at the second position to which a direction or a position of the distance measuring device changes in at least one of an upward direction and a downward direction from the first posture or the first position by controlling the support device.

In the aspect of (1), the prescribed object may include a post of a pole or a post of a fence, and the pole or the fence may be an object that is hard for the distance measuring device to detect without changing the posture or the position.

According to another aspect of the present invention, there is provided a control device that is mounted in a mobile object, the control device including: a distance measuring device that is mounted in the mobile object and that emits electromagnetic waves to detect an object on the basis of a result of detection of the electromagnetic waves bouncing back from the object; a support device that supports the distance measuring device; a position recognizer configured to recognize a position of the mobile object; and a controller configured to control a state of the support device such that a support state of the distance measuring device changes between at least a first posture and a second posture or changes between a first position and a second position, wherein, when it is determined that the mobile object reaches or approaches a prescribed range on the basis of a result of recognition from the position recognizer, the controller is configured to cause the distance measuring device to emit electromagnetic waves in a state in which the distance measuring device is supported in the first posture or at the first position and then to cause the distance measuring device to emit electromagnetic waves in a state in which the distance measuring device is supported in the second posture or at the second position to which a direction or a position of the distance measuring device changes in at least one of an upward direction and a downward direction from the first posture or the first position by controlling the support device.

In the aspect of (3), the prescribed range may be a range including an entrance of a park, an entrance of a parking lot, or an entrance of a facility in which an object that is hard for the distance measuring device to detect without changing the posture or the position is present.

In the aspect of one of (1) to (4), the distance measuring device may emit electromagnetic waves while changing an angle in a vertical direction every predetermined angle without changing the support state.

In the aspect of (5), a rate of change of an angle in a direction in which the distance measuring device emits electromagnetic waves due to change of the distance measuring device from the first posture to the second posture may be smaller than the predetermined angle.

In the aspect of one of (1) to (4), the controller may be configured to cause the distance measuring device to emit electromagnetic waves while changing an angle in a vertical direction every predetermined angle in each of a plurality of postures including the first posture and the second posture.

In the aspect of (7), reference emission directions of the plurality of postures when the distance measuring device emits electromagnetic waves while changing the angle in the vertical direction every predetermined angle for each of the plurality of postures may be included in the predetermined angle and not overlap.

In the aspect of (7) or (8), the controller may be configured to change the posture of the distance measuring device at equal intervals and to cause the distance measuring device to emit electromagnetic waves while changing the angle in the vertical direction at which electromagnetic waves are emitted every predetermined angle regardless of the support device in each of the plurality of changed postures.

In the aspect of one of (1) to (9), the controller may be configured to cause the mobile object to avoid an obstacle to the mobile object when the obstacle is detected as a result of detection in a process of causing the distance measuring device to emit electromagnetic waves.

According to another aspect of the present invention, there is provided a control method that is performed by a computer of a mobile object including a distance measuring device that is mounted in a mobile object and that emits electromagnetic waves to detect an object on the basis of a result of detection of the electromagnetic waves bouncing back from the object and a support device that supports the distance measuring device, the control method including: a step of detecting a prescribed object present in a traveling direction of the mobile object; a step of controlling a state of the support device such that a support state of the distance measuring device changes between at least a first posture and a second posture or changes between a first position and a second position; and a step of, when the object has been detected, causing the distance measuring device to emit electromagnetic waves in a state in which the distance measuring device is supported in the first posture or at the first position and then causing the distance measuring device to emit electromagnetic waves in a state in which the distance measuring device is supported in the second posture or at the second position to which a direction or a position of the distance measuring device changes in at least one of an upward direction and a downward direction from the first posture or the first position by controlling the support device.

According to another aspect of the present invention, there is provided a non-transitory computer storage medium storing a program causing a computer of a mobile object including a distance measuring device that is mounted in a mobile object and that emits electromagnetic waves to detect an object on the basis of a result of detection of the electromagnetic waves bouncing back from the object and a support device that supports the distance measuring device to perform: a process of detecting a prescribed object present in a traveling direction of the mobile object; a process of controlling a state of the support device such that a support state of the distance measuring device changes between at least a first posture and a second posture or changes between a first position and a second position; and a process of, when the object has been detected, causing the distance measuring device to emit electromagnetic waves in a state in which the distance measuring device is supported in the first posture or at the first position and then causing the distance measuring device to emit electromagnetic waves in a state in which the distance measuring device is supported in the second posture or at the second position to which a direction or a position of the distance measuring device changes in at least one of an upward direction and a downward direction from the first posture or the first position by controlling the support device.

According to the aspects of (1) to (12), it is possible to support more accurate detection of an object.

### BRIEF DESCRIPTION OF THE DRAWINGS

FIG. 1 is a diagram illustrating an example of configurations of a mobile object and a control device according to an embodiment.

FIG. 2 is a perspective view of an object from above.

FIG. 3 is a diagram schematically illustrating a situation in which a LIDAR emits light.

FIG. 4 is a diagram illustrating an example of an arrangement state of the LIDAR.

FIG. 5 is a diagram illustrating an example of a state of the LIDAR when a first support slides in a minus X direction.

FIG. 6 is a diagram conceptually illustrating light irradiation areas as seen from the mobile object.

FIG. 7 is a diagram illustrating an example of a rope which is an obstacle.

FIG. 8 is a flowchart illustrating an example of a routine of processes which are performed by the control device.

FIG. 9 is a diagram illustrating an example of an arrangement state of the LIDAR.

FIG. 10 is a diagram illustrating an example of a state in which a LIDAR according to Modified Example 2 emits light.

FIG. 11 is a diagram illustrating an example of a state in which a LIDAR according to Modified Example 3 emits light.

### DETAILED DESCRIPTION

Hereinafter, a control device that is mounted in a mobile object, a control method, and a storage medium according to an embodiment of the present invention will be described with reference to the accompanying drawings. A mobile object moves on both a roadway and a predetermined area other than a roadway. The predetermined area is, for example, a walkway. The predetermined area may be some or all of a road shoulder, a bicycle lane, a public open space, and the like or may include all of a walkway, a road shoulder, a bicycle lane, and a public open space. In the following description, it is assumed that the predetermined area is a walkway. In the following description, the word “walkway” can be appropriately replaced with “predetermined area”.

In the following description, a forward direction of the mobile object is referred to as a plus X direction, a rearward direction of the mobile object is referred to as a minus X direction, a rightward direction (a right side when the mobile object faces the plus X direction) in a direction perpendicular to a front-rear direction is referred to as a plus Y direction, a leftward direction (a left side when the mobile object faces the plus X direction) in the direction perpendicular to the front-rear direction is referred to as a minus Y direction, a vertical upward direction which is perpendicular to the X direction and to the Y direction is referred to as a plus Z direction, and a vertical downward direction which is perpendicular to the X direction and to the Y direction is referred to as a minus Z direction.

### Embodiment

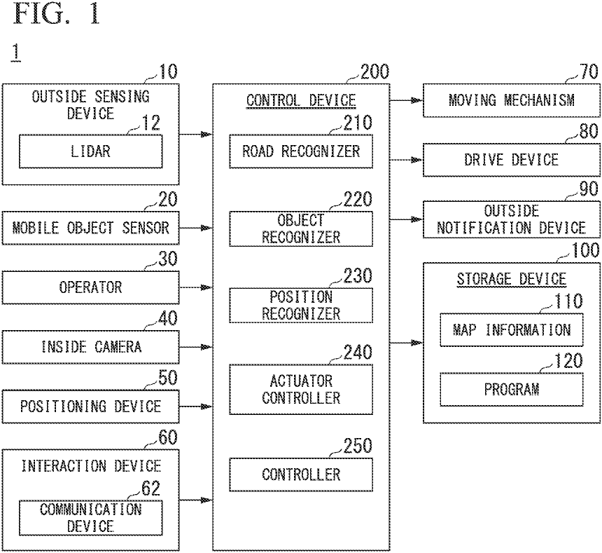

FIG. 1 is a diagram illustrating an example of configurations of a mobile object 1 and a control device 200 according to an embodiment. For example, an outside sensing device 10, a mobile object sensor 20, an operator 30, an inside camera 40, a positioning device 50, an interaction device 60, a moving mechanism 70, a drive device 80, an outside notification device 90, a storage device 100, and a control device 200 are mounted in the mobile object 1. Out of these constituents, some constituents which are not essential to implement functions according to the present invention may be omitted.

The outside sensing device 10 includes various types of devices that sense a forward space in a traveling direction of the mobile object 1. The outside sensing device 10 includes a Light Detection and Ranging device (LIDAR) 12. The outside sensing device 10 includes, for example, an outside camera, a radar device, and a sensor fusion device. The outside sensing device 10 outputs information indicating the detection result (such as an image or a position of an object) to the control device 200. The LIDAR 12 will be described later.

The mobile object sensor 20 includes, for example, a speed sensor, an acceleration sensor, a yaw rate (angular velocity) sensor, a direction sensor, and an operation amount sensor that is attached to the operator 30. The operator 30 includes, for example, an operator used to send an instruction for acceleration/deceleration (for example, an accelerator pedal or a brake pedal) and an operator used to send an instruction for steering (for example, a steering wheel). In this case, the mobile object sensor 20 may include an accelerator operation amount sensor, a brake depression amount sensor, and a steering torque sensor. The mobile object 1 may include an operator (for example, a rotary operator with a shape other than a ring shape, a joystick, or a button) in a mode other than that of the operator 30 described above.

The inside camera 40 images at least a head of an occupant of the mobile object 1 from a front. The inside camera 40 is a digital camera using an imaging device such as a charge-coupled device (CCD) or a complementary metal oxide semiconductor (CMOS). The inside camera 40 outputs a captured image to the control device 200.

The positioning device 50 is a device that measures a position of the mobile object 1. The positioning device 50 is, for example, a global navigation satellite system (GNSS) receiver and is configured to identify the position of the mobile object 1 on the basis of signals received from GNSS satellites and to output the identified position as position information. The position information of the mobile object 1 may be estimated from a position of a Wi-Fi base station to which a communication device which will be described later is connected.

The interaction device 60 includes, for example, a speaker, a microphone, a touch panel, and a communication device 62. The interaction device 60 appropriately processes voice of the occupant collected by the microphone, transmits the processed voice to a server device via a network using the communication device 62, and outputs vocal information from the speaker on the basis of information returned from the server device. The interaction device 60 may be referred to as an agent device, a concierge device, or an assistance device. The server device has a voice recognizing function, a natural language processing function, a semantic interpretation function, and a reply details determining function. The interaction device 60 may transmit the position information to the server device, and the server device may return information of a corresponding facility on the basis of the position information and a guidance request uttered by the occupant (for example, “What’s a good ramen restaurant near here?”). In this case, vocal guidance such as “If you turn left up here, there’s one there”, is performed by the interaction device 60. The interaction device 60 is not limited thereto and has a function of receiving a natural utterance from the occupant and returning an appropriate reply. The interaction device 60 has a function of holding a simple conversation without using the server device such as asking a question and receiving a reply, and may ask the occupant a question in response to a request from the control device 200.

The moving mechanism 70 is a mechanism for causing the mobile object 1 to move on a road. The moving mechanism 70 is, for example, a wheel group including turning wheels and driving wheels. The moving mechanism 70 may include legs for multiped walking.

The drive device 80 causes the mobile object 1 to move by outputting a force to the moving mechanism 70. For example, the drive device 80 includes a motor that drives the driving wheels, a battery that stores electric power to be supplied to the motor, a steering device that adjusts a turning angle of the turning wheels, and a brake device that is controlled on the basis of information input from the control device 200 or information input from the operator 30. The drive device 80 may include an internal combustion engine or a fuel cell as a driving force output means or a power generation means.

The outside notification device 90 is provided, for example, in an outer panel of the mobile object 1 and includes a lamp, a display device, or a speaker for notifying the outside of the mobile object 1 of information. The outside notification device 90 performs different operations in a state in which the mobile object 1 is moving on a walkway and in a state in which the mobile object 1 is moving on a roadway. For example, the outside notification device 90 is controlled such that the lamp emits light when the mobile object 1 is moving on a walkway and the lamp does not emit light when the mobile object 1 is moving on a roadway. The color of light emitted from the lamp is preferably a color which is determined by the law. The outside notification device 90 may be controlled such that the lamp emits green light when the mobile object 1 is moving on a walkway and the lamp emits blue light when the mobile object 1 is moving on a roadway. When the outside notification device 90 is a display device, the outside notification device 90 displays text or graphics indicating “moving on a walkway” when the mobile object 1 is moving on a walkway.

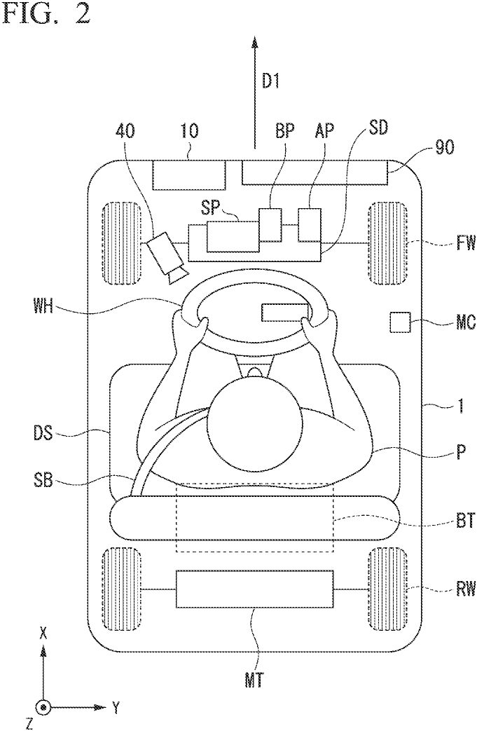

FIG. 2 is a perspective view of the mobile object 1 when seen from above. In the drawing, FW denotes turning wheels, RW denotes driving wheels, SD denotes a steering device, MT denotes a motor, and BT denotes a battery. The steering device SD, the motor MT, and the battery BT are included in the drive device 80. AP denotes an accelerator pedal, BP denotes a brake pedal, WH denotes a steering wheel, SP denotes a speaker, and MC denotes a microphone. The illustrated mobile object 1 is a single-seated mobile object, and an occupant P sits on a driver’s seat and wears a seat belt SB. Arrow D1 denotes a traveling direction (a velocity vector) of the mobile object 1. The outside sensing device 10 is provided in the vicinity of a front end of the mobile object 1, and the inside camera 40 is provided at a position at which the head of the occupant P can be imaged from the front of the occupant P. The outside notification device 90 which is a display device is provided in the vicinity of the front end of the mobile object 1.

Referring back to FIG. 1, the storage device 100 is a non-transitory storage device such as a hard disk drive (HDD), a flash memory, or a random access memory (RAM). Map information 110, a program 120 that is executed by the control device 200, and the like are stored in the storage device 100. The storage device 100 is illustrated outside of the frame of the control device 200 in FIG. 1, but the storage device 100 may be included in the control device 200.

### Control Device

The control device 200 includes, for example, a road recognizer 210, an object recognizer 220, a position recognizer 230, an actuator controller 240, and a controller 250. The road recognizer 210, the object recognizer 220, the position recognizer 230, the actuator controller 240, and the controller 250 are implemented, for example, by causing a hardware processor such as a central processing unit (CPU) to execute a program (software). Some or all of these constituents may be implemented by hardware (a circuit unit including circuitry) such as a large scale integration (LSI) chip, an application-specific integrated circuit (ASIC), a field-programmable gate array (FPGA), or a graphics processing unit (GPU), or may be implemented by a combination of software and hardware. The program may be stored in a storage device (not illustrated) in advance or may be stored in a detachable storage medium (a non-transitory storage medium) such as a DVD or a CD-ROM and may be installed in the storage device by setting the storage medium to a drive device.

The road recognizer 210 recognizes whether the mobile object 1 is moving on a roadway or moving on a walkway. The road recognizer 210 recognizes whether the mobile object 1 is moving on a roadway or moving on a walkway, for example, by analyzing an image captured by the outside camera of the outside sensing device 10. An example of image analysis is semantic segmentation. The road recognizer 210 classifies pixels in a frame of an image into classes (such as a roadway, a walkway, a boundary, and an object), labels the pixels, recognizes that the mobile object 1 is moving on a roadway when many pixels which are labeled as a roadway are included in an area in front of the mobile object 1, and recognizes that the mobile object 1 is moving on a walkway when many pixels which are labeled as a walkway are included in the area in front of the mobile object 1 in the image. The road recognizer 210 is not limited thereto and may recognize that the mobile object 1 is moving on a roadway when a vehicle is recognized in the area in front of the mobile object 1 in the image, and recognize that the mobile object 1 is moving on a walkway when a pedestrian is recognized in the area in front of the mobile object 1 in the image. The road recognizer 210 may recognize that the mobile object 1 is moving on a roadway when a road surface area in front of the mobile object 1 in the image has a large width, and recognize that the mobile object 1 is moving on a walkway when the road surface area in front of the mobile object 1 in the image has a small width. The road recognizer 210 may recognize whether the mobile object 1 is moving on a roadway or moving on a walkway by comparing the position information of the mobile object 1 with the map information 110. In this case, the map information needs to have such precision that a walkway and a roadway can be distinguished on the basis of position coordinates thereof. When the “predetermined area” is not only a walkway, the road recognizer 210 performs the same process on a roadside strip (road shoulder), a bicycle lane, a public open space, or the like.

The object recognizer 220 recognizes an object near the mobile object 1 on the basis of an output of the outside sensing device 10. Examples of the object include some or all of obstacles such as a mobile object such as a vehicle, a bicycle, or a pedestrian; a traveling road boundary such as a lane marking, a step difference, a guard rail, a road shoulder, or a median; a structure installed on a road such as a road sign or a signboard; a fallen object located (fallen) on a traveling road; and an object present in the traveling direction of the mobile object 1. For example, the object recognizer 220 may acquire information such as presence, position, and type of another mobile object by inputting the captured image from the outside camera to a trained model which has been trained to output information such as presence, position, and type of an object when an image captured by the outside camera of the outside sensing device 10 is input. The type of another mobile object may be estimated on the basis of sizes in an image, intensities of reflected waves received by a radar device of the outside sensing device 10, or the like. The object recognizer 220 may acquire, for example, a speed of another mobile object detected using Doppler Shift or the like by the radar device. The object recognizer 220 may recognize an obstacle on the basis of information input from the LIDAR 12 as will be described later. The object recognizer 220 may be included in the outside sensing device instead of in the control device 200.

The position recognizer 230 acquires information of a position measured by the positioning device 50 and determines whether the acquired position is a prescribed position. Information of the prescribed position is stored in the storage device 100.

Process details of the actuator controller 240 will be described later.

The controller 250 generates a trajectory, for example, with reference to information of the traveling road based on the output of the road recognizer 210 and information of the object based on the output of the object recognizer 220, and controls the drive device 80 such that the mobile object 1 travels autonomously along the generated trajectory. A trajectory is a trajectory along which the mobile object 1 will travel autonomously (without requiring a driver’s operation) in the future. A trajectory includes, for example, a speed element. For example, a trajectory is expressed by sequentially arranging points (trajectory points) at which the mobile object 1 is to arrive. Trajectory points are points at which the mobile object 1 is to arrive at intervals of a predetermined traveling distance (for example, about several [m]) along a road, and a target speed and a target acceleration at intervals of a predetermined sampling time (for example, the decimal point [sec]) are generated in addition as a part of the trajectory. Trajectory points may be positions at which the mobile object 1 is to arrive at sampling timings every predetermined sampling time. In this case, information of a target speed or a target acceleration is expressed by intervals between the trajectory points.

For example, when the mobile object 1 is moving on a roadway, the controller 250 controls the motor MT, the brake device, and the steering device of the drive device 80 such that the mobile object 1 moves while maintaining a distance from an object near the mobile object 1 to be equal to or greater than a first distance. When the mobile object 1 is moving on a walkway, the controller 250 controls the motor MT, the brake device, and the steering device of the drive device 80 such that the mobile object 1 moves while maintaining a distance from an object in front of the mobile object 1 to be equal to or greater than a second distance. The second distance is, for example, a distance longer than the first distance. When the mobile object 1 moves with a driver’s operation, the controller 250 controls the drive device 80 on the basis of a user’s operation of an operator such that the mobile object 1 moves in a mode corresponding to the operation.

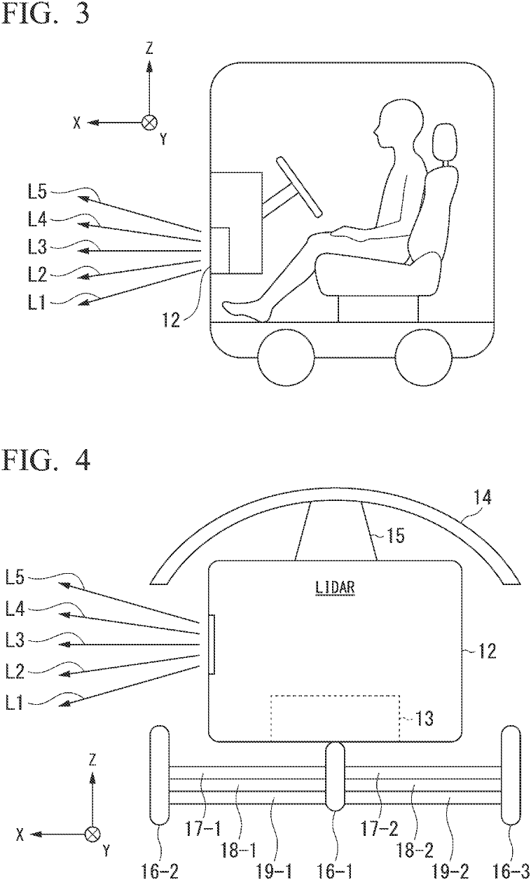

FIG. 3 is a diagram schematically illustrating a situation in which the LIDAR 12 emits light. The LIDAR 12 detects a distance to an outline of an object by emitting light, detecting reflected light, and measuring a time T from emission to detection. The LIDAR 12 can change light emission direction in both an elevation angle or a depression angle (a vertical emission direction) and an azimuth angle (a horizontal emission direction). For example, the LIDAR 12 repeatedly performs an operation of performing a scan while changing the horizontal emission direction with the vertical emission direction fixed, changing the vertical emission direction, and then performing a scan while changing the horizontal emission direction with the vertical emission direction fixed to the changed angle.

In the following description, a vertical emission direction is referred to as a “layer”, one scan which is performed while changing the horizontal emission direction with the layer fixed is referred to as “cycle scan”, and a horizontal emission direction is referred to as “azimuth”. For example, the layer is set to a finite number of L1 to Ln (where n is a natural number). Changing of the layer is performed, for example, discontinuously in angles like L1→L4→L2→L5→L3... such that light emitted in a previous cycle does not interfere with detection in a current cycle. Changing of the layer is not limited thereto and may be performed continuously in angles. Light may be emitted while changing the layer with the azimuth direction fixed.

In the example illustrated in FIG. 3, the LIDAR 12 performs a cycle scan in each of the layers L1 to L5 and emits light in an azimuth defined for each layer. In other words, the LIDAR 12 emits light in a combination direction of each of a plurality of prescribed angles in the vertical direction and each of a plurality of prescribed angles in the horizontal direction.

FIG. 4 is a diagram illustrating an example of an arrangement state of the LIDAR 12. The LIDAR 12 is disposed in a housing 14. The LIDAR 12 is supported by a bush member 15 and a first support 16-1. The bush member 15 is provided between the LIDAR 12 and the housing 14 (on a plus Z side of the LIDAR 12). The bush member 15 is a cushioning member that fixes a position of the LIDAR 12 or absorbs vibration for the LIDAR 12. The LIDAR 12 is formed of an elastic member such as rubber.

The first support 16-1 is provided on a minus Z side of the LIDAR 12. A second support 16-2 is provided on a plus X side of the first support 16-1, and a third support 16-3 is provided on a minus X side of the first support 16-1. The second support 16-2 and the third support 16-3 are fixed to a body of the mobile object 1 or the like. For example, a first spring member 17-1, a first damper 18-1, and a first actuator 19-1 are disposed between the first support 16-1 and the second support 16-2. For example, a second spring member 17-2, a second damper 18-2, and a second actuator 19-2 are disposed between the first support 16-1 and the third support 16-3.

The first actuator 19-1 includes a rod, and the rod extends to the minus X side from a reference position to cause the first support 16-1 to slide to the minus X side with rotation of a motor which is not illustrated. When the rod of the first actuator 19-1 returns to the reference position, the first spring member 17-1 and the first damper 18-1 absorb energy for moving the first support 16-1 to the plus X side, and thus, the first support 16-1 returns smoothly to the reference position.

The second actuator 19-2 includes a rod, and the rod extends to the plus X side from a reference position to cause the second support 16-2 to slide to the plus X side with rotation of a motor which is not illustrated. When the rod of the second actuator 19-2 returns to the reference position, the second spring member 17-2 and the second damper 18-2 absorb energy for moving the first support 16-1 to the minus X side, and thus, the first support 16-1 returns smoothly to the reference position.

The LIDAR 12 includes, for example, a sensor that detects a change in posture of the LIDAR 12 such as an inertial measurement unit (IMU) 13. The actuator controller 240 of the control device 200 detects a posture (or a position) of the LIDAR 12 on the basis of information acquired from the IMU 13 and changes the posture of the LIDAR 12 on the basis of the result of detection. For example, the actuator controller 240 changes the posture of the LIDAR 12 by controlling the first actuator 19-1 or the second actuator 19-2 such that the position of the first support 16-1 slides.

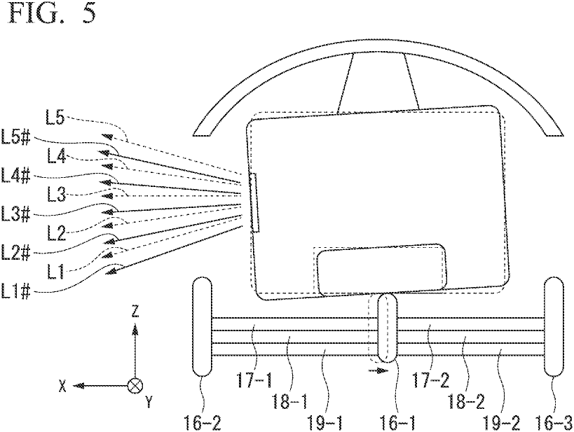

FIG. 5 is a diagram illustrating an example of a state of the LIDAR 12 when the first support 16-1 slides in the minus X side. When the actuator controller 240 causes the rod of the first actuator 19-1 to extend to the minus X side, the first support 16-1 slides from the reference position to the minus X side. The center of gravity of the LIDAR 12 moves forward, and the LIDAR 12 is inclined to the minus Z side. Accordingly, the light emission direction of the LIDAR 12 is the minus Z side from the emission direction corresponding to the reference position. As illustrated in FIG. 5, the light emission direction at the reference position is L1 to L5, and the light emission direction after the first support 16-1 has slid is L1# to L5#.

As described above, the control device 200 causes the LIDAR 12 to emit light in a state in which the LIDAR 12 is supported in a first posture and causes the LIDAR 12 to emit light in a state in which the LIDAR 12 is supported in a second posture which is deviated upward or downward from the direction (an angle of the emission direction) of the LIDAR 12 in the first posture.

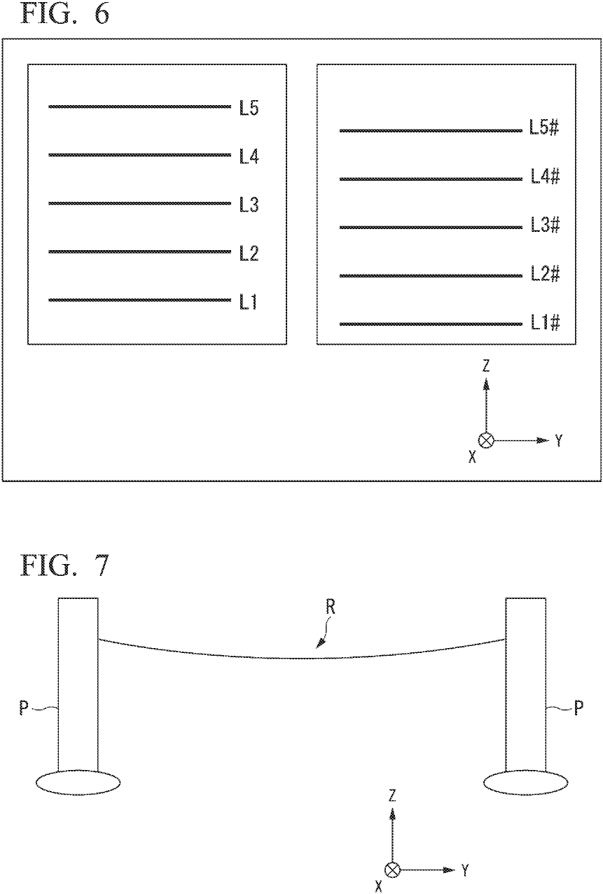

FIG. 6 is a diagram conceptually illustrating a light emission area when seen from the mobile object 1. As illustrated in FIG. 6, light irradiation areas when the emission direction is L1 to L5 and light irradiation areas when the emission direction is L1# to L5# are different (or partially overlap). That is, the LIDAR 12 emits electromagnetic waves while changing the vertical emission direction every predetermined angle regardless of a support state by the first support 16-1.

For example, a rate of change of an angle of the light emission direction of the LIDAR 12 in the second posture from the light emission direction of the LIDAR 12 in the first posture is less than a rate of change of an angle unit. The angle unit is an angle unit in the vertical direction (an angle difference between neighboring layers) when the LIDAR 12 emits light while changing the angle in the vertical direction regardless of control of the actuator controller 240 (control of the first support 16-1). In the example illustrated in FIG. 6, the posture of the LIDAR 12 is controlled such that the emission direction L5# is interposed between the emission direction L4 and the emission direction L5.

When the posture changes in three or more steps instead of two steps, a change of the posture is included in an angle range between neighboring layers. The angle units when the LIDAR 12 emits light in the changed postures may be equal or substantially equal. In FIG. 6, for example, when the posture changes in three steps, the posture of the LIDAR 12 is controlled such that the light emission directions in a first posture are L1 to L5, the light emission directions in a second posture are L1# to L5#, and the light emission directions in a third posture are L1## to L5## (not illustrated). For example, the control is performed such that the emission direction L5# and the emission direction L5## are different, and the control is performed such that the emission directions are interposed between the emission direction L4 and the emission direction L5. For example, when light is emitted in the order of the emission direction L5, the emission direction L5#, and the emission direction L5## from the plus Z side, the angle difference between the emission direction L5 and the emission direction L5#, the angle difference between the emission direction L5# and the emission direction L5##, and the angle difference between the emission direction L5## and the emission direction L4 are equal or substantially equal. When the posture changes in four or more steps, emission of light can also be performed while changing the posture in the same way. In this case, the reference emission directions of a plurality of postures when the LIDAR 12 emits electromagnetic waves while changing the angle in the vertical direction every predetermined angle for the plurality of postures are in a predetermined angle range and do not overlap. For example, when the emission direction L5 to the emission direction L5### (not illustrated) are reference emission directions, the emission direction L5# to the emission direction L5### are interposed between the emission direction L5 and the emission direction L4 and do not overlap.

For example, when the object recognizer 220 detects an object in a state in which the LIDAR 12 is at a reference position, light of the LIDAR 12 does not reach the object depending on a type or a shape of the object and thus may not recognize the object. For example, the object recognizer 220 may not be able to detect an object with a small width in the vertical direction and a large length in the horizontal direction (for example, an object parallel to the azimuth direction) such as a rope R or a chain suspended between two poles P as illustrated in FIG. 7, an object with a plurality of large gaps such as a fence, or the like using the LIDAR 12.

Therefore, in this embodiment, the actuator controller 240 changes the light emission direction of the LIDAR 12 in a plurality of steps in the vertical direction and causes the LIDAR 12 to emit light as described above. Accordingly, a target area in which an object is to be detected can be comprehensively irradiated with light, and the object recognizer 220 can recognize an object on the basis of a result of detection from the LIDAR 12.

### Flowchart

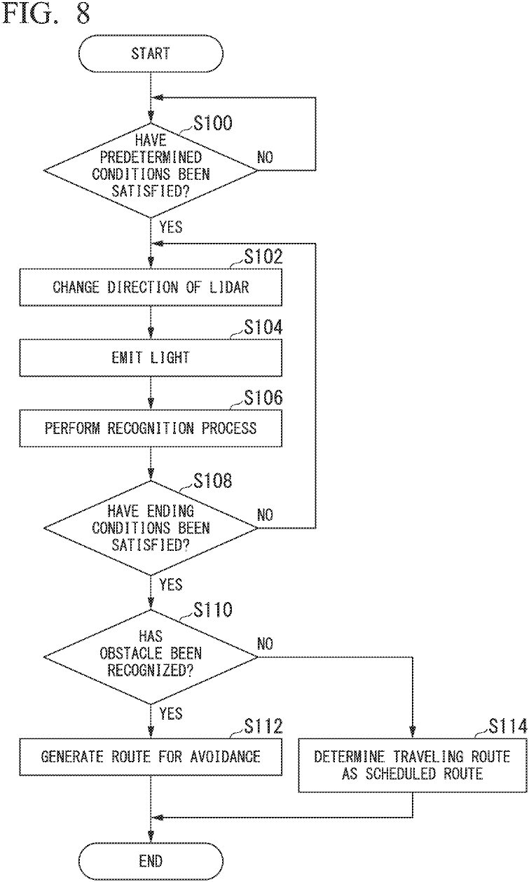

FIG. 8 is a flowchart illustrating an example of a routine of processes which is performed by the control device 200. In this routine, for example, it is assumed that the LIDAR 12 emits light at a reference position and the object recognizer 220 performs a process of detecting an object on the basis of the result of detection from the LIDAR 12. In this embodiment, it is assumed that the controller 250 controls the mobile object 1 such that the mobile object 1 travels autonomously.

First, the actuator controller 240 determines whether predetermined conditions have been satisfied (Step S100). Whether predetermined conditions have been satisfied may be determined, for example, on the basis of a result of recognition from the object recognizer 220. The predetermined conditions include, for example, a condition that a prescribed object is present at a position in a predetermined distance from the mobile object in the traveling direction of the mobile object 1. The prescribed object is, for example, a target object which is assumed to be an object that is hard for the LIDAR 12 to recognize such as the poles illustrated in FIG. 7 or posts of a fence (posts of a fence with a wire net suspended therebetween). Information of the prescribed object is stored, for example, in the storage device 100. The actuator controller 240 determines that the predetermined conditions have been satisfied when the object recognizer 220 has recognized a prescribed object with reference to the information stored in the storage device 100. The predetermined conditions may is a condition that the mobile object 1 is scheduled to travel in a predetermined area. The predetermined area is, for example, an area between two poles or an area between two posts.

Whether the predetermined conditions have been satisfied may be determined, for example, on the basis of a result of recognition from the position recognizer 230. The predetermined conditions is, for example, a condition that the mobile object 1 reaches or approaches a prescribed range or position. The prescribed range or position is a range or position in which an object that is hard for the LIDAR 12 to recognize is provided as described above. The prescribed range or position is, for example, a range including an entrance of a park, an entrance of a parking lot, or an entrance of a facility or a position thereof. The predetermined conditions may include a condition that the mobile object 1 is scheduled to pass through a predetermined place. The predetermined place is, for example, an entrance of a park, an entrance of a parking lot, or an entrance of a facility. When it is determined in the aforementioned routine that the predetermined conditions have been satisfied, a process after the mobile object 1 has stopped or decelerated may be performed.

When the predetermined conditions have been satisfied, the actuator controller 240 controls the first actuator 19-1 or the second actuator 19-2 such that the emission direction of the LIDAR 12 changes (Step S102) and the LIDAR 12 emits light at the changed position (Step S104). Then, the object recognizer 220 performs a recognition process of recognizing an object on the basis of the result of detection from the LIDAR 12 (Step S106). In the cycles of the routine, the LIDAR 12 emits light to different areas (partially overlapping areas), and the object recognizer 220 recognizes whether there is an obstacle on the basis of information input from the LIDAR 12 after each cycle has been completed.

Then, the actuator controller 240 determines whether ending conditions have been satisfied (Step S108). The ending conditions include, for example, a condition that the processes of Steps S104 and S106 are performed at a plurality of preset positions. The ending conditions may include, for example, a condition that the LIDAR 12 is shifted from a first position to an N-th position (where N is an arbitrary natural number). For example, when N is 3, the actuator controller 240 locates the LIDAR 12 at a first position in a first cycle of the routine and causes an object recognizing process to be performed at the first position, locates the LIDAR 12 at a second position in a second cycle which is a subsequent cycle of the routine and causes the object recognizing process to be performed at the second position, and locates the LIDAR 12 at a third position in a third cycle which is a subsequent cycle of the routine and causes the object recognizing process to be performed at the third position, and it is determined that the ending conditions have been satisfied.

When the ending conditions have not been satisfied, the routine returns to Step S102. When the ending conditions have been satisfied, the controller 250 determines whether an obstacle has been recognized in the recognition process in the current cycle of the routine (Step S110).

When an obstacle has been recognized, the controller 250 generates a route for avoiding the obstacle and controls the mobile object 1 such that the mobile object 1 moves along the generated route (Step S 112). The controller 250 repeatedly performs the process of causing the LIDAR 12 to emit light predetermined times, and causes the mobile object 1 to avoid an obstacle to the mobile object 1 when the obstacle has been detected as the result of detection in the repeated processes. When an obstacle has not been recognized, the controller 250 determines the current traveling route as a scheduled route and controls the mobile object 1 such that the mobile object 1 moves along the determined route (Step S114).

The order of processes or the process details may be appropriately modified. For example, when an obstacle has been recognized in the processes of Steps S102 to S108, the process of Step S112 is performed, and thus, the mobile object 1 may be controlled such that the mobile object 1 avoids the obstacle. In the aforementioned example, when the predetermined conditions have been satisfied, the mobile object 1 may stop or decelerate, and the processes of Step S102 or steps subsequent thereto may be performed.

By causing the actuator controller 240 to change the position of the LIDAR 12 as described above, it is possible to perform support for more accurately detecting an object. Since the object recognizer 220 recognizes an object using the result of detection from the LIDAR 12 for each changed position, it is possible to more accurately recognize an object.

### Modified Example 1

An example in which the LIDAR 12 is supported by the first support 16-1, the bush member 15, or the like and the position of the LIDAR 12 changes with sliding of the first support 16-1 has been described above, but the LIDAR 12 may be supported or changed in position by another device or member instead.

FIG. 9 is a diagram illustrating an example of an arrangement state of the LIDAR 12. For example, the LIDAR 12 may be attached to and supported by a support unit 300 such that the LIDAR 12 is not movable. A rotary unit 310 is provided on the minus Z side at the center in the X direction of the support unit 300. When the rotary unit 310 rotates with driving of an actuator which is not illustrated, the LIDAR 12 rotates along with the support unit 300. Accordingly, the light emission direction of the LIDAR 12 changes.

As described above, the change in position of the LIDAR 12 may be controlled by rotation of the rotary unit 310.

### Modified Example 2

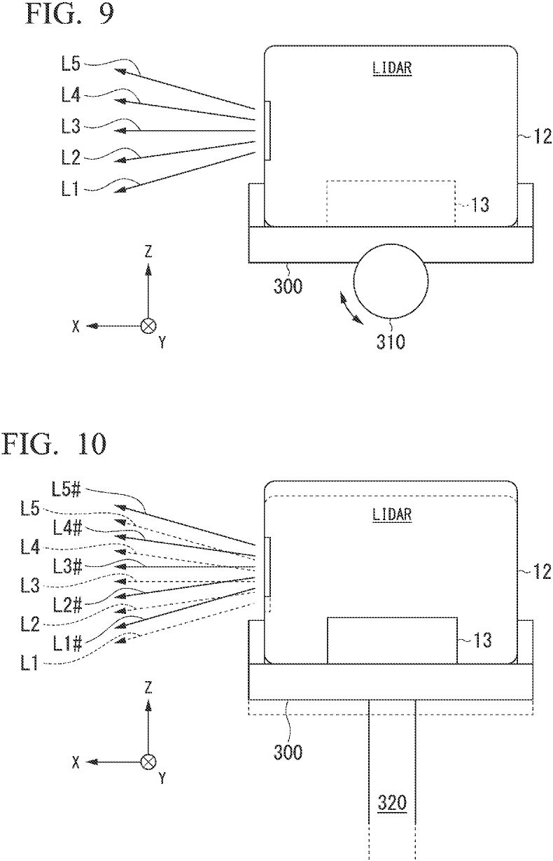

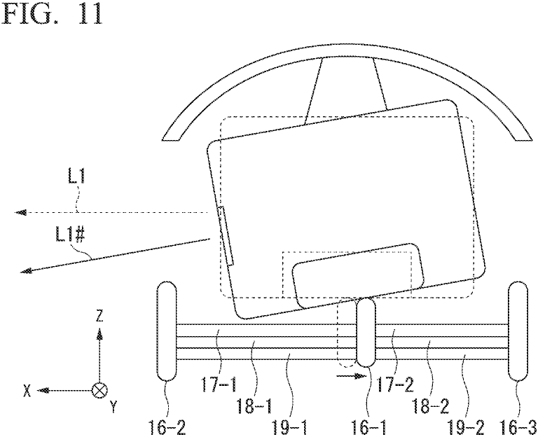

An example in which the facing angle of the LIDAR 12 is changed to change the light emission direction has been described above, but the light emission direction may be changed by changing the position in the vertical direction of the LIDAR 12 as illustrated in FIG. 10 instead. For example, after the LIDAR 12 has emitted light in the directions L1 to L5 at a first position, a drive unit 320 changes the position of the LIDAR 12 upward and locates the LIDAR 12 at a second position. The LIDAR 12 emits light in the directions L1# to L5# at the second position.

By causing the LIDAR 12 to change its position and to emit light as described above, it is possible to perform support for more accurately detecting an object.

### Modified Example 3

An example in which the LIDAR 12 emits light in each combination direction of a plurality of prescribed angles in the vertical direction and a plurality of prescribed angles in the horizontal direction has been described above, but the LIDAR 12 may emit light in each of a plurality of angles in the horizontal direction at one angle in the vertical direction instead. FIG. 11 is a diagram illustrating an example of a state in which a LIDAR 12 according to Modified Example 3 emits light. As illustrated in FIG. 11, the LIDAR 12 may emit light in the direction L1 at a first position and then emit light in the direction L1# at a second position. The LIDAR 12 may emit light while changing the position thereof a plurality of times.

By causing the LIDAR 12 to emit light while changing an angle in the vertical direction as described above, it is possible to perform support for more accurately detecting an object.

According to the aforementioned embodiment, when an object has been detected or when a mobile object reaches or approaches a prescribed position, the control device 200 can perform support for more accurately detecting an object by causing the LIDAR 12 to emit light in a state in which the LIDAR 12 is supported in a first posture or position and then causing the LIDAR 12 to emit light in a state in which the LIDAR 12 is supported in a second posture or position to which the direction or position of the LIDAR 12 is changed upward or downward from the first posture or position.

Specific control for causing the LIDAR 12 to emit light in a state in which the LIDAR 12 is supported in the first posture or position and then causing the LIDAR 12 to emit light in a state in which the LIDAR 12 is supported in the second posture or position to which the direction or position of the LIDAR 12 is changed upward or downward from the first posture or position may be performed when the mobile object 1 is moving on a walkway, and may not be performed when the mobile object 1 is moving on a roadway. For example, the control device 200 may perform the specific control only when the mobile object 1 is traveling on a walkway or entering the walkway on the basis of a result of recognition indicating whether the mobile object 1 is moving on a walkway or moving on a roadway. This is because an object that is hard for the LIDAR 12 to detect such as a pole, a chain, or a fence is not present on a roadway. Accordingly, it is possible to curb unnecessary control, to reduce a process load, and to allow the mobile object 1 to move more smoothly.

An example in which the specific control is performed on the LIDAR 12 has been described above, but the specific control may be performed on a distance measuring device (for example, a radar device included in the outside sensing device 10) that detects an object on the basis of a result of detection of electromagnetic waves bouncing and returning from an object by emitting electromagnetic waves such as a millimeter wave radar instead (in addition).

The aforementioned embodiment may be described as follows:

A control device of a mobile object including:
a distance measuring device that is mounted in a mobile object and that detects an object on the basis of a result of detection of electromagnetic waves bouncing back from the object by emitting electromagnetic waves;
a support device that supports the distance measuring device;
a storage device that stores a program; and
a hardware processor,
wherein, by causing the hardware processor to execute the program stored in the storage device, the control device performs a process of detecting a prescribed object present in a traveling direction of the mobile object, a process of controlling a state of the support device such that a support state of the distance measuring device changes between at least a first posture and a second posture or changes between a first position and a second position, and a process of, when the object has been detected, causing the distance measuring device to emit electromagnetic waves in a state in which the distance measuring device is supported in the first posture or at the first position and then causing the distance measuring device to emit electromagnetic waves in a state in which the distance measuring device is supported in the second posture or at the second position to which a direction or a position of the distance measuring device changes in at least one of an upward direction and a downward direction from the first posture or the first position by controlling the support device.

While a mode for carrying out the present invention has been described above with reference to an embodiment, the present invention is not limited to the embodiment, and various modifications and substitutions can be performed thereon without departing from the gist of the present invention.

What is claimed is:

1. A control device that is mounted in a mobile object, the control device comprising:
a distance measuring device that is mounted in a mobile object and that emits electromagnetic waves to detect an object on the basis of a result of detection of the electromagnetic waves bouncing back from the object;
a support device that supports the distance measuring device; and
a controller configured to detect a prescribed object present in a traveling direction of the mobile object and to control a state of the support device such that a support state of the distance measuring device changes between at least a first posture and a second posture or changes between a first position and a second position,
wherein, when the object has been detected, the controller is configured to cause the distance measuring device to emit electromagnetic waves in a state in which the distance measuring device is supported in the first posture or at the first position and then to cause the distance measuring device to emit electromagnetic waves in a state in which the distance measuring device is supported in the second posture or at the second position to which a direction or a position of the distance measuring device changes in at least one of an upward direction and a downward direction from the first posture or the first position by controlling the support device.

2. The control device according to claim 1,
wherein the prescribed object includes a post of a pole or a post of a fence, and
wherein the pole or the fence is an object that is hard for the distance measuring device to detect without changing the posture or the position.

3. A control device that is mounted in a mobile object, the control device comprising:
a distance measuring device that is mounted in the mobile object and that emits electromagnetic waves to detect an object on the basis of a result of detection of the electromagnetic waves bouncing back from the object;
a support device that supports the distance measuring device;
a position recognizer configured to recognize a position of the mobile object; and
a controller configured to control a state of the support device such that a support state of the distance measuring device changes between at least a first posture and a second posture or changes between a first position and a second position,
wherein, when it is determined that the mobile object reaches or approaches a prescribed range on the basis of a result of recognition from the position recognizer, the controller is configured to cause the distance measuring device to emit electromagnetic waves in a state in which the distance measuring device is supported in the first posture or at the first position and then to cause the distance measuring device to emit electromagnetic waves in a state in which the distance measuring device is supported in the second posture or at the second position to which a direction or a position of the distance measuring device changes in at least one of an upward direction and a downward direction from the first posture or the first position by controlling the support device.

4. The control device according to claim 3, wherein the prescribed range is a range including an entrance of a park, an entrance of a parking lot, or an entrance of a facility in which an object that is hard for the distance measuring device to detect without changing the posture or the position is present.

5. The control device according to claim 1, wherein the distance measuring device emits electromagnetic waves while changing an angle in a vertical direction every predetermined angle without changing the support state.

6. The control device according to claim 5, wherein a rate of change of an angle in a direction in which the distance measuring device emits electromagnetic waves due to change of the distance measuring device from the first posture to the second posture is smaller than the predetermined angle.

7. The control device according to claim 1, wherein the controller is configured to cause the distance measuring device to emit electromagnetic waves while changing an angle in a vertical direction every predetermined angle in each of a plurality of postures including the first posture and the second posture.

8. The control device according to claim 7, wherein reference emission directions of the plurality of postures when the distance measuring device emits electromagnetic waves while changing the angle in the vertical direction every predetermined angle for each of the plurality of postures are included in the predetermined angle and do not overlap.

9. The control device according to claim 7, wherein the controller is configured to change the posture of the distance measuring device at equal intervals and to cause the distance measuring device to emit electromagnetic waves while changing the angle in the vertical direction at which electromagnetic waves are emitted every predetermined angle regardless of the support device in each of the plurality of changed postures.

10. The control device according to claim 1, wherein the controller is configured to cause the mobile object to avoid an obstacle to the mobile object when the obstacle is detected as a result of detection in a process of causing the distance measuring device to emit electromagnetic waves.

11. A control method that is performed by a computer of a mobile object including a distance measuring device that is mounted in a mobile object and that emits electromagnetic waves to detect an object on the basis of a result of detection of the electromagnetic waves bouncing back from the object and a support device that supports the distance measuring device, the control method comprising:
a step of detecting a prescribed object present in a traveling direction of the mobile object;
a step of controlling a state of the support device such that a support state of the distance measuring device changes between at least a first posture and a second posture or changes between a first position and a second position; and
a step of, when the object has been detected, causing the distance measuring device to emit electromagnetic waves in a state in which the distance measuring device is supported in the first posture or at the first position and then causing the distance measuring device to emit electromagnetic waves in a state in which the distance measuring device is supported in the second posture or at the second position to which a direction or a position of the distance measuring device changes in at least one of an upward direction and a downward direction from the first posture or the first position by controlling the support device.
